(19) United States
(12) Patent Application Publication
(10) Pub. No.: US 2017/0186322 A1
(43) Pub. Date: Jun. 29, 2017

(54) METHOD TO DETERMINE AN EVASION TRAJECTORY FOR A VEHICLE

(71) Applicant: Adam Opel AG, Russelsheim (DE)

(72) Inventors: Frank BONARENS, Ruesselsheim (DE); Jens FERDINAND, Ruesselsheim (DE)

(73) Assignee: GM GLOBAL TECHNOLOGY OPERATIONS LLC, Detroit, MI (US)

(21) Appl. No.: 15/383,799

(22) Filed: Dec. 19, 2016

(30) Foreign Application Priority Data
Dec. 18, 2015 (DE) 102015016544.5

(51) Int. Cl. G08G 1/16; B62D 15/02

(52) U.S. Cl. CPC G08G 1/165; B62D 15/0265; B60W 2420/42; B60W 2420/52; B60W 2710/20; B60W 10/20

(57) ABSTRACT

A method for finding an evasive trajectory for avoiding an obstacle for a vehicle on a roadway. A component of a candidate trajectory parallel to the roadway is determined by selecting weighting coefficients of a first weighted sum of orthogonal functions of time. A component of the candidate trajectory orthogonal to the roadway is determined by selecting weighting coefficients of a second weighted sum of the orthogonal functions. An optimization parameter for the candidate trajectory is calculated. At least one coefficient of at least one of the sums is modified and the procedure is repeated when the optimization parameter does not reach a termination criterion.

### CROSS-REFERENCE TO RELATED APPLICATION

This application claims priority to German Patent Application No. 102015016544.5, filed Dec. 18, 2015, which is incorporated herein by reference in its entirety.

### TECHNICAL FIELD

The present invention pertains to a method for determining an evasive trajectory, on which a vehicle can drive around an obstacle, as well as means for implementing this method.

### BACKGROUND

A method and a device for avoiding collisions of a vehicle with an obstacle are known from EP 2 141 057 A1. This document proposes to predict the trajectory of the vehicle based on measuring signals of various sensors and to deliver collision avoidance control information to a brake control unit and a steering control unit in case the predicted trajectory exceedingly approaches the obstacle. However, it remains unclear how the collision avoidance control information is structured and how it can be processed in the brake control unit and the steering control unit in order to actually avoid an impending collision.

### SUMMARY

An objective of the present invention can be seen in developing a method that actually makes it possible to avoid a collision with a detected obstacle.

According to an embodiment of the invention, this objective is attained with a method for determining an evasive trajectory, on which a vehicle can drive around an obstacle on a roadway, wherein a) a component of a candidate trajectory extending parallel to the roadway is defined by selecting weighting coefficients of a first weighted sum of orthogonal functions of the time, b) a component of the candidate trajectory extending perpendicular to the roadway is defined by selecting weighting coefficients of a second weighted sum of the orthogonal functions, c) an optimization parameter for the candidate trajectory is calculated, and d) at least one coefficient of at least one of the sums is varied and step c) is repeated if the optimization parameter does not reach a stop criterion.

The time until an expected collision on the candidate trajectory occurs may particularly serve as optimization parameter.

In this case, the stop criterion is preferably defined in that this time is longer than the time required for traveling the candidate trajectory.

It is also conceivable that a candidate trajectory is only considered as an evasive trajectory if it fulfills one or more of the following boundary conditions: compliance with an upper limit of the acceleration of the vehicle in order to take into account the fact that the acceleration of the vehicle is regardless in which direction limited by the coefficient of friction between tires and roadway, compliance with a lower limit of the distance of the vehicle from the obstacle because the collision avoidance fails in any case if this distance becomes 0, or disappearance of the speed component of the vehicle extending orthogonal to the roadway at the end of the evasive trajectory. If it is not possible to determine an evasive trajectory that fulfills this condition, it may in fact be possible to drive around the obstacle, but the vehicle is subsequently carried off the roadway due to its non-disappearing transversal speed.

This boundary condition can be taken into account in different ways. The compliance with the upper limit of the acceleration can be checked, in particular, by calculating a scalar cost function for each candidate trajectory.

With respect to other boundary conditions, particularly those concerning the end of the evasive trajectory, it is possible to select the value for at least one coefficient, which fulfills the boundary condition together with previously selected values of other coefficients, beforehand in step a) or b) such that trajectories, which cannot be considered as evasive trajectories anyway because they do not fulfill the boundary conditions, are not even selected and analyzed as candidate trajectories in the first place.

In order to systematically search for a favorable evasive trajectory, it is advantageous if the candidate trajectories can be parameterized. This is achieved with the aid of weighting coefficients; they reduce the problem of determining an ideal or at least approximately ideal evasive trajectory to determining a point in a multidimensional vector space, wherein the number of dimensions of the vector space corresponds to the number of weighting coefficients of the parallel and the orthogonal component.

The parallel and the orthogonal component may respectively be polynomials. Trigonometric and algebraic polynomials may particularly be considered, i.e. the orthogonal functions are the functions of the form:

$$\frac{{e}^{i 2 π mkt / T} - {e}^{- i 2 π mkt / T}}{2 i}$$

$$\frac{{e}^{i 2 π mkt / T} + {e}^{- i 2 π mkt / T}}{2 i}$$

the period T of which corresponds to the duration of the evasive trajectory and in which k has integral values between 0 and n or in which the power of functions have integral exponents. The algebraic polynomials—which are also referred to as polynomial functions—are preferred due to their simple computability.

In order to accelerate the determination of a suitable evasive trajectory, it is desirable to sensibly define as many of the weighting coefficients as possible beforehand such that they do not have to be optimized iteratively. Since the current coordinate values of the vehicle parallel and orthogonal to the roadway are known (or can be assumed to be zero), at least one of these coordinate values can be predefined as coefficient of a zero order term of at least one of the polynomials.

If the polynomials are algebraic polynomials, the first time derivative of the current coordinate value of the vehicle parallel or orthogonal to the roadway may furthermore be predefined as coefficient of a first order term of at least one of the polynomials; in other words: the current speed of the vehicle parallel to the roadway—which is usually available in the form of a speedometer signal—and the current speed perpendicular to the roadway—which is calculated thereof, if applicable, based on the steering wheel angle or the like—are used as coefficients of first order terms.

In addition, the second time derivative of the coordinate value of the vehicle parallel or orthogonal to the roadway—i.e. the directly measured acceleration of the vehicle or the acceleration calculated based on the known speed—may be predefined as coefficient of a second order term of at least one of the polynomials.

In this way, the dimensions of the optimization problem can be reduced to 6 beforehand. The computing effort required until a usable evasive trajectory is determined or its existence can be negated with sufficient certainty can thereby be significantly reduced.

The higher the order of the polynomials, the more accurately an arbitrary evasive trajectory can be approximated by means of the polynomials and the higher the certainty that a suitable evasive trajectory can also be found if it actually exists. This is the reason why each polynomial should comprise at least two terms, the coefficients of which are varied in step c).

On the other hand, no more than four terms of each polynomial should be varied in step c) in order to limit the computing effort.

Another objective of the invention can be seen in disclosing a driver assistance system for a motor vehicle that is able to quickly and reliably determine a suitable evasive trajectory in a hazardous situation.

According to an embodiment of the invention, this objective is attained with a driver assistance system for a motor vehicle that features a proximity sensor and a computer unit that is connected to the proximity sensor in order to carry out the above-described method when the proximity sensor detects an obstacle in the surroundings of the vehicle.

The computer unit may be connected to at least a steering system of the vehicle in order to steer the vehicle around the obstacle along the evasive trajectory. In order to realize a potentially required acceleration and/or deceleration of the vehicle along the evasive trajectory, the computer unit should preferably also be connected to an engine control and/or brake control.

The invention furthermore pertains to a computer program product comprising instructions that, when the computer program product is executed on a computer, enable this computer to carry out the above-described method or to operate as a computer unit in a driver assistance system in the above-described fashion, to a machine-readable data carrier, on which such instructions are recorded, as well as to a computer unit for a driver assistance system with a) means for defining a component of a candidate trajectory extending parallel to the roadway by selecting weighting coefficients of a first weighted sum of orthogonal functions; b) means for defining a component of the candidate trajectory extending orthogonal to the roadway by selecting weighting coefficients of a second weighted sum of the orthogonal functions; c) means for calculating an optimization parameter for the candidate trajectory and d) means for varying coefficients of at least one of the sums and reactivating the means c) if the optimization parameter does not reach a stop criterion.

### BRIEF DESCRIPTION OF THE DRAWINGS

Other characteristics and advantages of the invention can be gathered from the following description of exemplary embodiments with reference to the attached figures. In these figures,

FIG. 1 shows a typical traffic situation, in which the driver assistance system can be used;

FIG. 2 shows a block diagram of the driver assistance system; and

FIG. 3 shows a flow chart of an operating method of the driver assistance system.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description

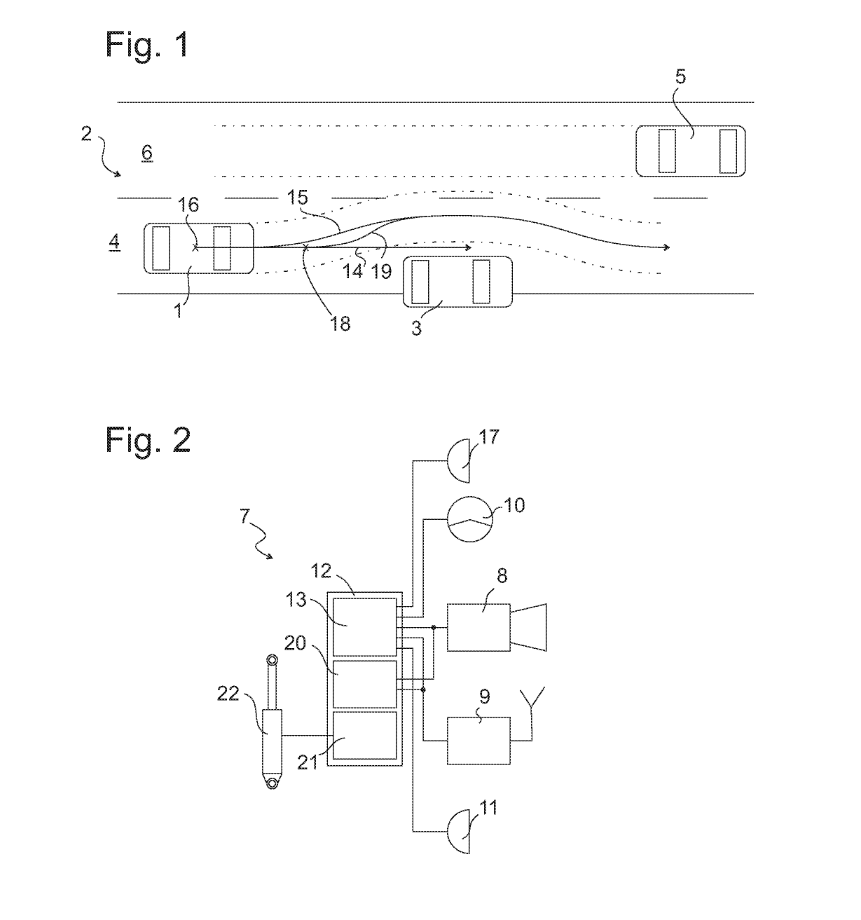

FIG. 1 shows a motor vehicle 1 that is equipped with the inventive driver assistance system and travels along a roadway 2, in this case a two-lane road. A vehicle parked on the roadside blocks part of one traffic lane 4 of the roadway 2, along which the motor vehicle 1 travels, and therefore represents an obstacle 3 that has to be avoided by the motor vehicle 1 in order to prevent a collision.

Another vehicle 5 travels in an oncoming traffic lane 6 of the roadway 2. However, an evasive maneuver of the motor vehicle 1 in the direction of the oncoming traffic lane 6 in order to avoid the obstacle 3 cannot provoke a collision with the vehicle 5.

FIG. 2 shows a block diagram of the driver assistance system 7, with which the motor vehicle 1 is equipped. The driver assistance system 7 comprises a speedometer 17 and a proximity sensor 8, in this case a camera that is directed at the roadway 2 located in front of the motor vehicle 1, in order to detect the course of the roadway 2, as well as potential obstacles 3 thereon such as the parked vehicle. Alternatively, a radar sensor may also be provided for the obstacle detection.

A conventional navigation system 9, which provides data on the course of the currently traveled roadway 2, may be provided in order to enhance the detection of the course of the road with the aid of the camera 8.

A steering wheel sensor 10 may serve for detecting the angle adjusted on the steering wheel of the motor vehicle 1 by the driver and for estimating a trajectory of the motor vehicle 1 resulting thereof; in addition, an acceleration sensor 11 may be provided for detecting longitudinal and lateral accelerations, to which the motor vehicle 1 is subjected along its trajectory.

A computer unit 12, typically a microcomputer, is connected to the sensors 8, 10, 11, 17 and the navigation system 9. A first utility program 13 running on this microcomputer serves for determining a predicted trajectory, on which the motor vehicle 1 will continue to move from its current position illustrated in FIG. 1. In this context, the term trajectory refers to a curve in a multidimensional space, the coordinates of which include at least the two position coordinates x and y parallel and perpendicular to the roadway 2, as well as a time coordinate. The determination of the predicted trajectory is based on the data on the previous trajectory of the motor vehicle 1 delivered by the speedometer 17, the steering wheel sensor 10 and the acceleration sensor 11, if applicable with consideration of the further course of the roadway 2, which can be derived from the data of the navigation system 9 and/or the camera 8.

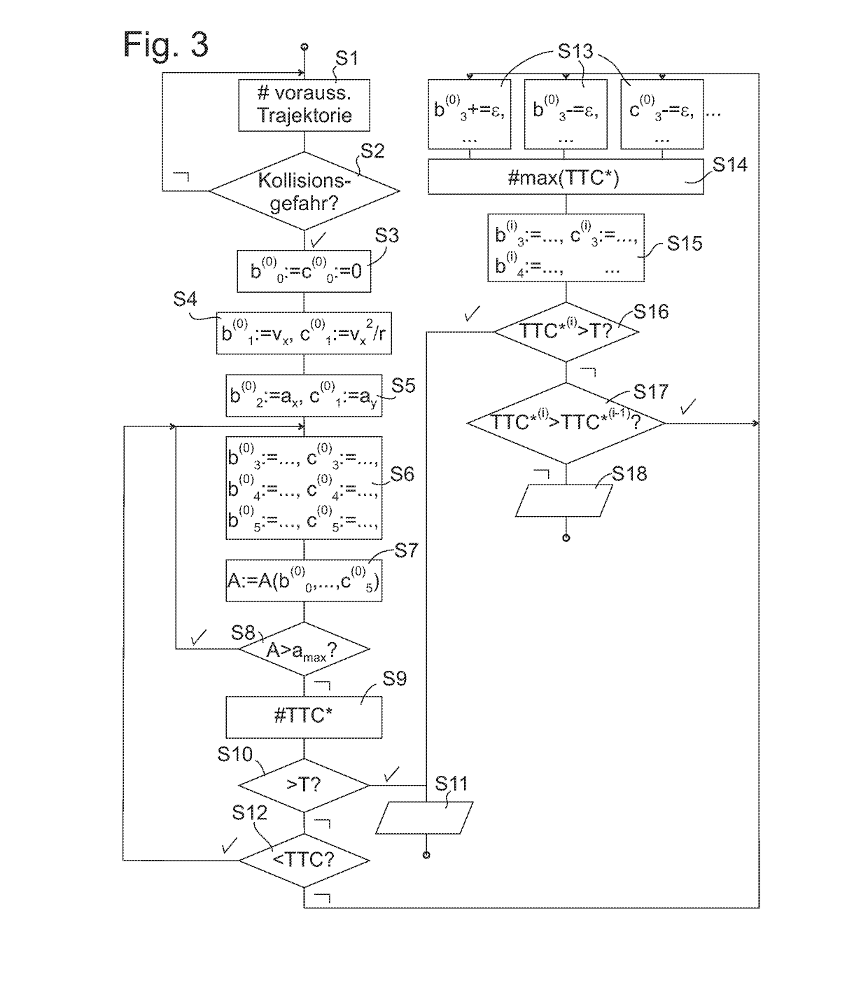

If the motor vehicle 1 has in the recent past moved straightforward on the roadway 2 and the further course of the roadway 2, as far as known, indicates that the roadway 2 continues in a straight line, the utility program 13 determines the straight trajectory identified by the reference symbol 14 in FIG. 1 as the predicted trajectory in step Si of the flow chart in FIG. 3.

The predicted trajectory 14 can generally be expressed in the form of two respective polynomials for coordinates x parallel to the roadway 2 and coordinates y perpendicular thereto:

x(t)=b₀+b₁t+b₂t²+b₃t³+b₄t⁴+b₅t⁵

y(t)=c₀+c₁t+c₂t²+c₃t³+c₄t⁴+c₅t⁵

wherein the initial position (b₀, c₀) can—under the assumption that the coordinate system x, y moves with the vehicle—be set equal to zero without loss of generality, (b₁, c₁) and (b₂, c₂) respectively represent the speed and the acceleration of the motor vehicle 1 at the current time t=0 and the remaining coefficients can be determined by adapting the polynomials to positions or speeds of the motor vehicle, which were determined at a previous point in time with the aid of the sensors 8, 10, 11, 17.

Based on this predicted trajectory 14 and the data of the proximity sensor 8, the utility program 13 checks if an obstacle 3 exists, with which the motor vehicle 1 could collide while driving along the predicted trajectory 14 (step S2). This check comprises on the one hand an evaluation of the current data of the proximity sensor with respect to the existence of an object other than the vehicle within the surrounding area monitored by the proximity sensor 8 and on the other hand a prediction of the trajectory of the object with the aid of previous data delivered by the proximity sensor 8.

The trajectories of the vehicle and the object are respectively predicted over an identical time period T of a few seconds into the future. A collision hazard is affirmed if the distance between the vehicle and the object falls short of a predefined limiting value at any time within this prediction time period, i.e. if the time TTC remaining until a collision occurs is shorter than T based on the predicted trajectories. This limiting value of the distance may be 0, but preferably has a positive value such that a collision hazard is not only affirmed when an actual collision is predicted, but already when a safety clearance between vehicle and object can no longer be maintained.

If a collision hazard is negated, the method returns to the starting point and once again begins with the determination of the predicted trajectory S1 after a predefined waiting period Δt.

In the traffic situation illustrated in FIG. 1, step S2 comprises the detection of a collision hazard in the form of the parked vehicle 3 while the vehicle is located at the point 16. In this case, the method branches out to step S3 in order to initially define a candidate evasive trajectory. Analogous to the predicted trajectory 14, the candidate evasive trajectory comprises two polynomials of the form:

x(t)=b⁽⁰⁾₀+b⁽⁰⁾₁t+b⁽⁰⁾₂t²+b⁽⁰⁾₃t³+b⁽⁰⁾₄t⁴+b⁽⁰⁾₅t ⁵

x(t)=c⁽⁰⁾₀+c⁽⁰⁾₁t+c⁽⁰⁾₂t²+c⁽⁰⁾₃t³+c⁽⁰⁾₄t⁴+c⁽⁰⁾₅t ⁵

If the coordinates refer to a fixed vehicle coordinate system, the zero order coefficients b⁽⁰⁾₀, c⁽⁰⁾₀ are initialized with the value 0 in S3.

The 1^{st} order coefficient ⁽⁰⁾₁ is initialized with the longitudinal speed vₓ of the vehicle measured by the speedometer 17 in S4. The curvature radius r of the current trajectory of the vehicle is calculated based on the steering angle measured by the steering wheel sensor 10 and the current transversal speed v_{y} is calculated from this curvature radius and from the longitudinal speed vₓ and set as coefficient c⁽⁰⁾₁.

The respective accelerations aₓ, a_{y} in the driving direction and transverse to the driving direction, which are measured by the sensor 11, may be set as coefficients b⁽⁰⁾₂, c⁽⁰⁾₂ in step S5; alternatively, they may also be numerically derived from values of the longitudinal and transversal speeds vₓ, v_{y}, which were obtained at different times.

An initial value is defined for the remaining coefficients b⁽⁰⁾₃, b⁽⁰⁾₄, b⁽⁰⁾₅, c⁽⁰⁾₃, c⁽⁰⁾₄, c⁽⁰⁾₅ in step S6; for the coefficients referred to as freely variable coefficients below, this initial value may, e.g., be permanently predefined or result from a random selection within a predefined finite interval.

Boundary conditions are taken into account in the selection of the initial values for the coefficients; for example, if one of these boundary conditions specifies that the acceleration in the direction extending parallel to the roadway should be 0 at the end of the evasive maneuver, only two of the coefficients b⁽⁰⁾₃, b⁽⁰⁾₄, b⁽⁰⁾₅ are freely variable whereas the third coefficient, preferably b⁽⁰⁾₅, is calculated in dependence on the two other coefficients such that the boundary condition:

aₓ(T)=\ddot{x}(T)=2b⁽⁰⁾₂T+6b⁽⁰⁾₃T+12b⁽⁰⁾₄T²+20b⁽⁰⁾₅T³=0

is fulfilled.

Two boundary conditions may have to be fulfilled with respect to the motion transverse to the roadway, namely that the coordinate y(T) transverse to the roadway is 0, i.e. that the vehicle is once again correctly positioned along its original trajectory, and that the transversal speed v_{y}=0 at the end of the evasive maneuver. After one of the coefficients, e.g. c⁽⁰⁾₃, has been freely selected, both other coefficients c⁽⁰⁾₄, c⁽⁰⁾₅ may be defined by the boundary conditions in this case.

A cost function is calculated for the selected coefficients in step S7. The cost function contains at least one summand of the form:

$$A = {max}_{t ∈ [ 0 , T ]} \sqrt{\begin{matrix}{( 2 {b}_{2}^{( i )} + 6 {b}_{3}^{( i )} t + 12 {b}_{4}^{( i )} {t}^{2} + 20 {b}_{5}^{( i )} {t}^{3} )}^{2} + \\ {( 2 {c}_{2}^{( i )} + 6 {c}_{3}^{( i )} t + 12 {c}_{4}^{( i )} {t}^{2} + 20 {c}_{5}^{( i )} {t}^{3} )}^{2}\end{matrix}}$$

which provides a measure for the maximum acceleration, to which the vehicle is subjected for the duration of the candidate trajectory, namely from t=0 until t=T. If A exceeds a limiting value aₘₐₓ, which is predefined by the coefficient of friction of the wheels on the roadway, the candidate trajectory contains locations, at which the required acceleration of the vehicle exceeds the physically possible acceleration, such that the vehicle cannot follow this candidate trajectory. Such a candidate trajectory is discarded in S8.

If the vehicle is able to follow the candidate trajectory, the time TTC* remaining until a collision occurs is estimated anew in step S9 based on this candidate trajectory. In this case, it is taken into account that the collision with the vehicle 3 in fact can possibly be avoided on the candidate trajectory, but a potential collision with the vehicle 5 may occur instead. If the time TTC* is longer than T (S10), the collision hazard is assumed to be eliminated and the candidate trajectory is considered to be a suitable evasive trajectory for driving around the obstacles 3 and 5, wherein the computer unit 12 activates one or more actuators 22 in order to act upon the steering system, the brakes and the engine such that the vehicle follows the evasive trajectory (S11).

If the time TTC* estimated in S9 is shorter or exactly as long as the time TTC obtained in step 51, the method returns to step S6 in order to define new initial values for the variable coefficients b⁽⁰⁾₃, b⁽⁰⁾₄, b⁽⁰⁾₅, c⁽⁰⁾₃, c⁽⁰⁾₄, c⁽⁰⁾₅.

However, if the time TTC* estimated in S9 is longer than the time TTC obtained in step S1 (S12), it is possible to search for other, better combinations based on the combination of coefficients used in this estimation. This may be realized, e.g., in that one of the freely variable coefficients is respectively selected, as well as increased or decreased by a predefined increment, and the dependently variable coefficients are once again adapted such that the boundary conditions are fulfilled (S13), wherein the coefficient set among the obtained sets of coefficients, which corresponds to a candidate trajectory with accelerations <aₘₐₓ and delivers the highest value of TTC*, is then preserved as new coefficient set b⁽¹⁾₃, b⁽¹⁾₄, b⁽¹⁾₅, c⁽¹⁾₃, c⁽¹⁾₄, c⁽¹⁾₅ (S14, S15).

In step S16, it is once again checked if the value TTC*⁽ⁱ⁾ (i=1, 2, . . . ) of the preserved candidate trajectory is >T, wherein the vehicle is controlled along the evasive trajectory if this is the case. Otherwise, it is checked in S17 if TTC*⁽ⁱ⁾ is at least greater than the value TTC*⁽ⁱ⁻¹⁾, which was obtained in an immediately preceding iteration in step S14 or, if i=1, in step S9.

If this is the case, the method returns to step S13.

If this is not the case and i has at the same time reached a predefined minimum value, the method replies with the message that no suitable evasive trajectory exists (S18).

If this is not the case and the minimum value of i has not been reached, the method returns to step S13, but reduces the increment used in step S13.

According to an enhancement, it is proposed that, while the vehicle 1 is located at the point 16 at the current time t=0, the computer unit 12 not only analyzes the available candidate trajectories that originate from this point 16, but also candidate trajectories such as 19, which originate from a point 18 reached in the future if the car continues to drive along the predicted trajectory 14. If step S18 is reached during the analysis of these candidate trajectories, i.e. if no suitable evasive trajectory originating from the point 18 exists, this means that it is no longer possible to wait for an intervention by the driver and that, if an evasive trajectory originating from the point 16 exists, the computer unit 12 has to intervene in order to follow this evasive trajectory and thereby avoid the impending collision.

Although the preceding detailed description and the drawings concern certain exemplary embodiments of the invention, it goes without saying that they are only intended for elucidating the invention and should not be interpreted as restrictions to the scope of the invention. The described embodiments can be modified in various ways without deviating from the scope of the following claims and their equivalents. The description and the figures particularly also disclose characteristics of the exemplary embodiments that are not mentioned in the claims. Such characteristics may also occur in combinations other than those specifically disclosed herein. The fact that several such characteristics are mentioned together in the same sentence or in a different context therefore does not justify the conclusion that they can only occur in the specifically disclosed combination; instead, it should basically be assumed that individual characteristics of several such characteristics can also be omitted or modified as long as the functionality of the invention is not compromised.

1-15. (canceled)

16. A method for determining an evasive trajectory for driving a vehicle around an obstacle on a roadway comprising:
a) defining a component (x) of a candidate trajectory extending parallel to the roadway by selecting weighting coefficients of a first weighted sum of orthogonal functions;
b) defining a component (y) of the candidate trajectory extending perpendicular to the roadway by selecting weighting coefficients of a second weighted sum of the orthogonal functions;
c) calculating an optimization parameter for the candidate trajectory; and
d) varying at least one coefficient of at least one of the sums and repeating step c) if the optimization parameter does not reach a stop criterion.

17. The method according to claim 16, further comprising e) steering the vehicle around the obstacle along the evasive trajectory.

18. The method according to claim 16, wherein the optimization parameter is a time period until an expected collision occurs on the candidate trajectory.

19. The method according to claim 16, wherein a candidate trajectory is only considered as an evasive trajectory if it fulfills at least one of the following boundary conditions:
compliance with an upper limit of the acceleration of the vehicle;
compliance with a lower limit of the distance of the vehicle from the obstacle; and
disappearance of the speed component of the vehicle extending orthogonal to the roadway at the end of the evasive trajectory.

20. The method according to claim 19, wherein a scalar cost function is calculated based on at least one of the boundary conditions.

21. The method according to claim 19, wherein the value that fulfills the at least one boundary condition together with previously selected values of other coefficients is selected for at least one coefficient in step a) or b).

22. The method according to claim 16, wherein the parallel and the orthogonal components are polynomials.

23. The method according to claim 22, wherein the coordinate value of the vehicle parallel or orthogonal to the roadway at a current time is defined as coefficient of a zero order term (b⁽⁰⁾₀, c⁽⁰⁾₀) of at least one of the polynomials.

24. The method according to claim 22, in which the polynomials are algebraic polynomials.

25. The method according to claim 24, wherein the first time derivative of the coordinate value of the vehicle parallel or orthogonal to the roadway at the current time is predefined as coefficient of a first order term (b⁽⁰⁾₁, c⁽⁰⁾₁) of at least one of the polynomials.

26. The method according to claim 25, wherein the the second time derivative of the coordinate value of the vehicle parallel or orthogonal to the roadway at the current time is predefined (S5) as coefficient of a second order term (b⁽⁰⁾₂, c⁽⁰⁾₂) of at least one of the polynomials.

27. The method according to claim 24, wherein each polynomial comprises at least two terms (b⁽⁰⁾₃, b⁽⁰⁾₄, b⁽⁰⁾₅, c⁽⁰⁾₃, c⁽⁰⁾₄, c⁽⁰⁾₅), the coefficients of which are varied in step d).

28. The method according to claim 27, wherein no more than four terms of each polynomial are varied in step d).

29. A non-transitory machine-readable medium comprising instructions are recorded on the medium that when executed on a computer to carry out the method according to claim 16.

30. A driver assistance system for a motor vehicle comprising a proximity sensor configured to detect an obstacle in the surroundings of the vehicle, and a computer unit operably coupled to the proximity sensor, wherein the computer unit is configured to:
a) define a component (x) of a candidate trajectory extending parallel to the roadway by selecting weighting coefficients of a first weighted sum of orthogonal functions;
b) define a component (y) of the candidate trajectory extending perpendicular to the roadway by selecting weighting coefficients of a second weighted sum of the orthogonal functions;
c) calculate an optimization parameter for the candidate trajectory; and
d) vary at least one coefficient of at least one of the sums and repeating step c) if the optimization parameter does not reach a stop criterion.

31. The driver assistance system according to claim 30, wherein the computer unit is operably coupled to a steering system of the vehicle and configured to operate the steering system for steering the vehicle around the obstacle along the evasive trajectory.
